(19) United States
(12) Patent Application Publication
(10) Pub. No.: US 2014/0318382 A1
(43) Pub. Date: Oct. 30, 2014

(54) QUICK HEATING QUARTZ TOASTER

(71) Applicant: Standex International Corporation, Salem, NH (US)

(72) Inventors: Douglas L. Hornbeck, Cheyenne, WY (US); James E. Humphrey, Cheyenne, WY (US)

(73) Assignee: Standex International Corporation, Salem, NH (US)

(21) Appl. No.: 14/267,288

(22) Filed: May 1, 2014

Related U.S. Application Data
(63) Continuation-in-part of application No. 13/068,334, filed on May 9, 2011, now abandoned.
(60) Provisional application No. 61/395,257, filed on May 11, 2010.

(51) Int. Cl. A47J 37/08

(52) U.S. Cl. CPC A47J 37/08; A47J 37/0857; A47J 37/085
USPC 99/332; 99/373

(57) ABSTRACT

A commercial toaster apparatus having a “quick start” feature that nearly instantly changes from a “stand-by” mode to a “toasting” mode. The “quick start” mode is provided by changing the circuitry of some of the quartz heating elements from a series configuration to a parallel one wherein a higher voltage can be applied for a controlled amount of time to regulate the quartz heaters without adversely affecting the life span of the heating elements. Temperature probes are used to adjust the duty cycle of the apparatus to enable a uniform toast color as the cavity chamber temperature of the toaster changes over time. A sensor is also provided that determines when a last product is placed on the conveyer and the duty cycle has been completed such that the unit will automatically switch to a “stand-by” mode, thus reducing the energy requirements of the toaster.

This application is a continuation-in-part of U.S. application Ser. No. 13/068,334, filed May 9, 2011, now abandoned, which claims benefit of U.S. Provisional Application Ser. No. 61/395,257 filed May 11, 2010 pursuant to 35 USC §119(e).

### FIELD OF THE INVENTION

This invention relates to a toasting apparatus, in particular, a method and apparatus for quickly heating the quartz elements in a toasting apparatus.

### BACKGROUND OF THE INVENTION

The method of scorching bread to preserve it dates back to the Romans. Additionally, toasting makes the bread crunchier and thus provides an ideal surface for spreading all sorts of things. In fact, the word “toast” comes from the Latin terms torrere, tostum—meaning to scorch or burn. The tradition spread to Britain and the English colonists brought the tradition to America.

Electric toaster appliances date back at least to the early 1900's. The earliest electric toaster was invented by Charles Strite in 1919. The first units utilized an open resistive wire arrangement that upon having a current placed in the wire caused the wire to heat and glow. The untoasted slice of bread was placed in the unit adjacent to the heating element and left there for a period of time until the toast was properly browned. Since the toast frequently ended up ‘black’ due to forgetting to remove it in a timely manner, a timer was added and pop-up features were also added to remove the toast when done.

To provide for large quantities of toast products to be produced quickly, commercial toasters were developed that made use of a conveyor belt sandwiched between heating elements that typically use quartz-heating elements to provide the heat. In this manner, slices of bread or other products that are to be toasted are fed into the feed port in the top front of the appliance and a conveyor slowly passes the slices of bread between the heating elements. By controlling the length of time the slices of bread are exposed to the heating elements by controlling the speed and length of the conveyor and by controlling the temperature of heating elements, the toast can be uniformly done.

Once the slice of bread reaches the end of the conveyor, it is dropped into an exit below. For continuous operation, the unit can be designed to have an adjustable baffle that changes the direction of the exit from the bottom front of the unit to the rear.

Representative of this type of apparatus is APW Wyott's model XTRM-2. This device uses a radiant heat system with a convection pre-heat system to pre-dry the bread (or product to be toasted) in the loading zone. The unit is said to produce 800 slices of toast per hour.

While this device works well, it is does have some drawbacks. These units are typically heated with quartz heaters that heat up to infrared. Therefore, these heaters are able to provide a good heat transfer system. In order to ensure that the time spent toasting the product is uniform, the unit must be in the “stand-by” mode to allow the heating elements to reach proper toasting temperature before the slices of bread are presented to the conveyor. While the use of a “stand-by” position does reduce the energy requirements substantially, a problem is encountered when the unit must be switched from “stand-by” to “toasting” mode.

A toaster that has a “ready” mode that can be quickly heated to a toasting temperature without substantially shortening the life of the quartz heating elements is not found in the prior art.

### SUMMARY OF THE INVENTION

It is an aspect of the invention to provide a commercial toaster apparatus that has a quick start feature that nearly instantaneously changes the “stand-by” mode to “toasting” mode.

It is still another aspect of the invention to provide a commercial toaster apparatus that has heating elements that are made from quartz.

Another aspect of the invention is to provide a commercial toaster apparatus that features a conveyor to move the product to be toasted in the apparatus.

Another aspect of the invention is to provide a commercial toaster apparatus that uses a sensor that determines that when the last product was placed on the conveyor and has completed its cycle, the unit will automatically change to the “stand-by” mode thus reducing the energy requirements of the toaster.

Still another aspect of the invention is to provide a commercial toaster apparatus that has exterior surfaces cool-to-the-touch during toasting operations.

Another aspect of the invention is to provide a commercial toaster apparatus that has a “stand-by” mode wherein heating elements are cycled such that less current is running through the heating elements when in this mode to conserve energy.

Still another aspect of the invention is to provide a commercial toaster apparatus that saves energy yet is able to achieve a quick start feature by applying a higher voltage for a shorter period of time to heat the quartz heating elements from a “stand-by” mode to “heating” mode.

Another aspect of the invention is to provide a commercial toaster apparatus that uses temperature probes to adjust the duty cycle of the apparatus to enable a uniform toast color as the cavity temperature in the toaster changes over time.

Still another aspect of the invention is to provide a commercial toaster apparatus that has a user selectable switch for toast, bagels or muffins.

Another aspect of the invention is to provide a commercial toaster apparatus that has a plurality of user defined power levels in memory.

Finally, it is an aspect of the invention to provide a commercial toaster apparatus that switches the quartz heaters' connections between parallel and series configurations wherein a higher voltage can be applied for a controlled amount of time to quickly heat the quartz heaters without adversely affecting the life of the heaters.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is an isometric view of the toaster apparatus in accordance with the invention.

FIG. 2 is an isometric view of the toaster apparatus shown in FIG. 1 with the top and right side panels removed to show the four top quartz heating elements.

FIG. 3 is a schematic view of the four top quartz-heating elements connected in series shown connected in parallel to the four bottom elements also connected in series to provide the “start” mode and the “toast” mode.

FIG. 4 is a schematic view of the quartz heating elements shown in FIG. 3, now connected in a serial configuration for energy savings wherein the wattage for each quartz heater is now half of what it was in FIG. 3.

FIG. 5 is a flow chart of process steps in accordance with the invention without using a sensor to determine when the last product was placed on the conveyor and has completed its cycle.

FIG. 6 is a flow chart of the process steps in accordance with the invention using a sensor to determine when each product added to the conveyor adds time per product to determine total toast time and when the last product was placed on the conveyor and has completed its cycle.

FIG. 7 is an isometric view of the control panel of the toaster apparatus.

FIG. 8 is an isometric view of the toaster apparatus shown in FIG. 1 with the top and right side panels removed to show the four top quartz heating elements and the two temperature probes.

### DETAILED DESCRIPTION OF THE INVENTION

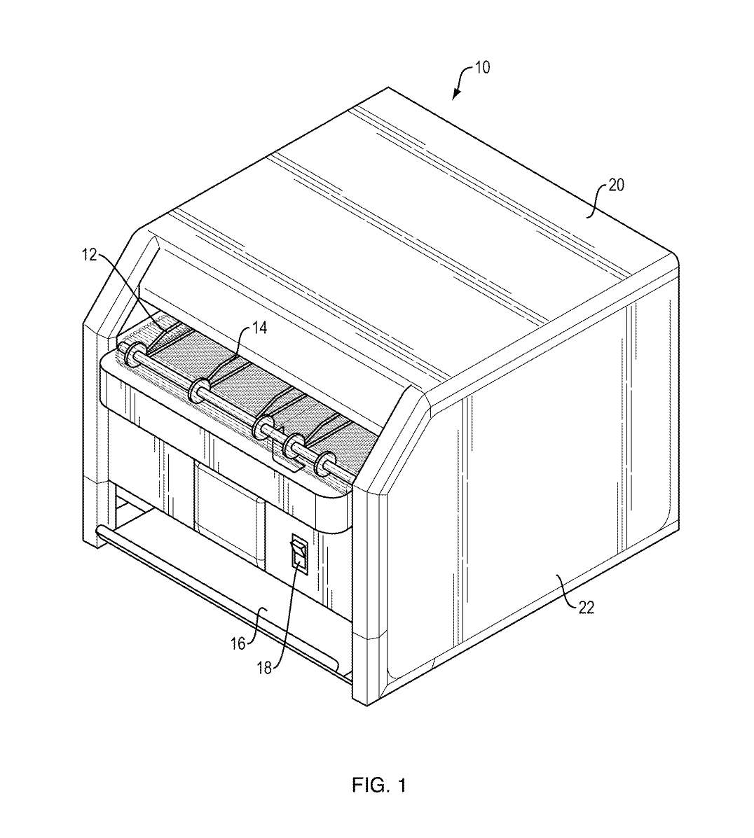

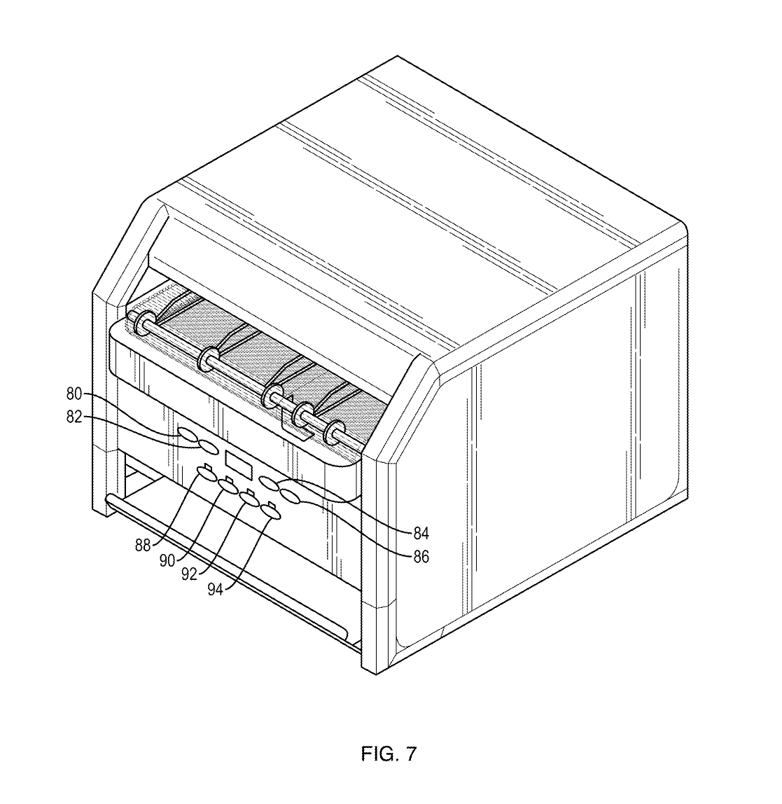

As shown in FIG. 1, toaster apparatus 10 has a similar appearance to most commercial conveying toaster apparatus. The product is placed in opening 12 onto conveyor 14, which moves the product (usually bread slices) between top and bottom heating elements at a predetermined rate such that the product will be properly toasted when it reaches the end of conveyor 14. The product then drops from conveyor 14 to be available to a user via opening 16. Switch 18 enables the user to turn the unit either on or off. Other controls (see FIG. 7) might include devices to control the speed of conveyor 14 to permit adjustment of the degree of toasting as well as indicator lights to tell when the unit is on/off or at a particular temperature such as heating, operating, stand-by, warming, etc.

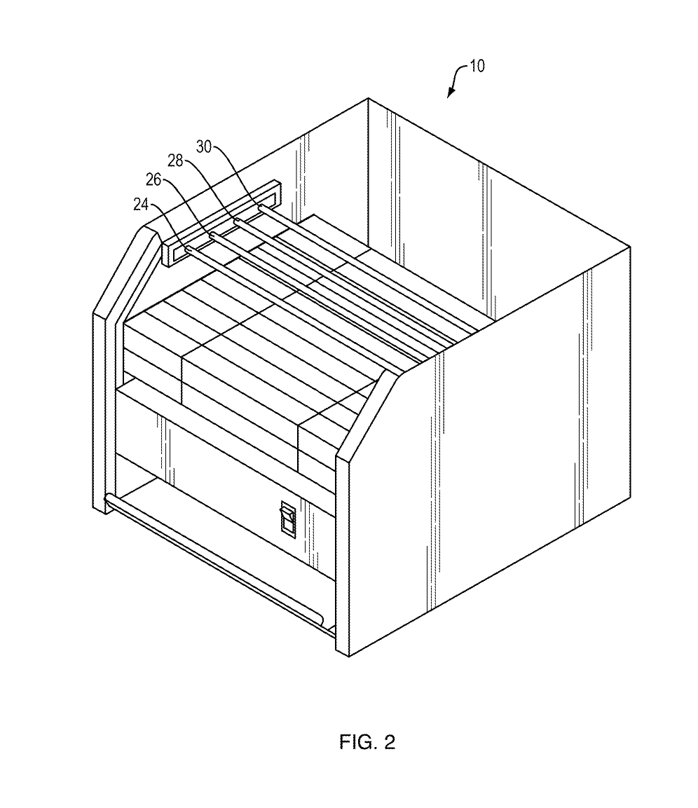

As shown in FIG. 2, panels 20 and 22 have been removed from toasting apparatus 10 to show top quartz heaters 24, 26, 28, and 30. Identical bottom quartz heaters (not shown) are positioned below conveyor 14 so that the product that is being toasted will be toasted on both sides at once without the need for placing the product through a second time to toast the side not toasted by top quartz heaters 24 through 30.

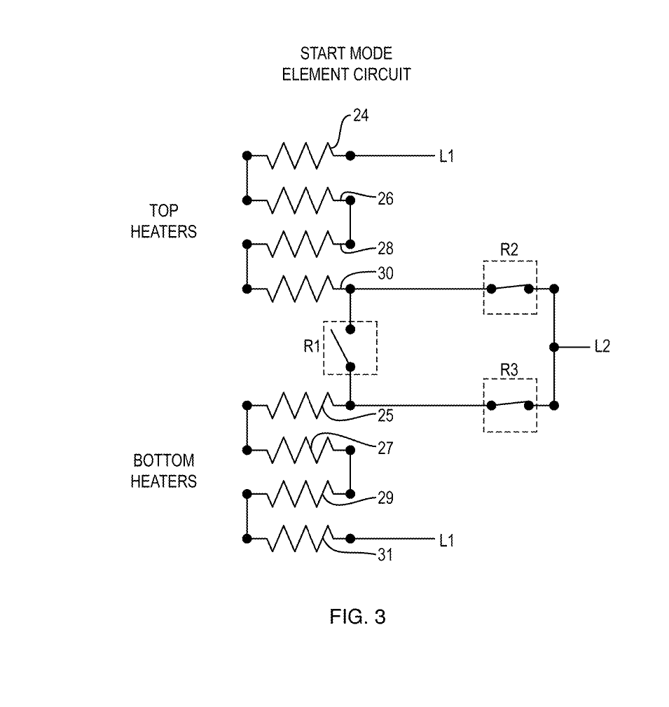

Referring now to FIG. 3, the schematic of top quartz heaters is shown in the “start” mode of operation. Heaters 24, 26, 28 and 30 are connected in series. Correspondingly, bottom heaters 25, 27, 29 and 31 would be configured similarly. The four top heaters (24, 26, 28, 30) and four bottom heaters (25, 27, 29, 31) are connected to the supply voltage (there would be models using supply voltages of 208, 240 and 110 respectively, the number of elements could depend on the supply voltage used). In the “start” mode, the maximum power is applied to the heaters to provide a quick start for toasting. The “toast” mode uses the same circuitry configuration but the power to heater is modified in accordance with the invention described later.

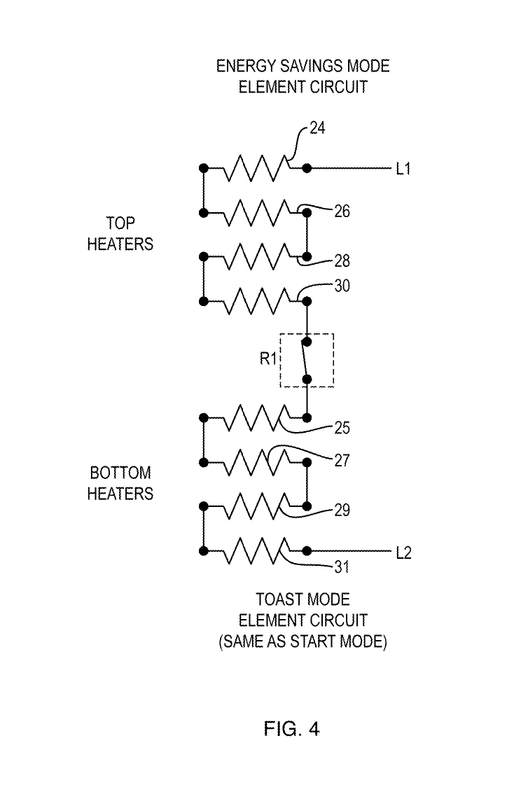

The schematic in FIG. 4 shows the invention in the “idle” or “energy savings” mode that causes the unit to be run using approximately ¼ of the power used in maximum wattage mode. By keeping the quartz heaters at a “stand-by”, the heaters are not permitted to go through the thermal shock of heating and completely cooling and then re-heating again. Thus, the heaters last longer. Further, by running at ¼ power, the toaster apparatus will use less energy and thus save the user energy costs. Present toasters with quartz heating elements maintain body cavity temperature by turning the heating elements “on” or “off”. This method of maintaining a desired toaster cavity temperature is extremely hard on the quartz heating elements and consequently reduces their life expectancy.

The switching and timing to change from the configurations shown in FIGS. 3 and 4 is accomplished using a digital controller and mechanical or solid state relays R1, R2, and R3 which are all well known in the art.

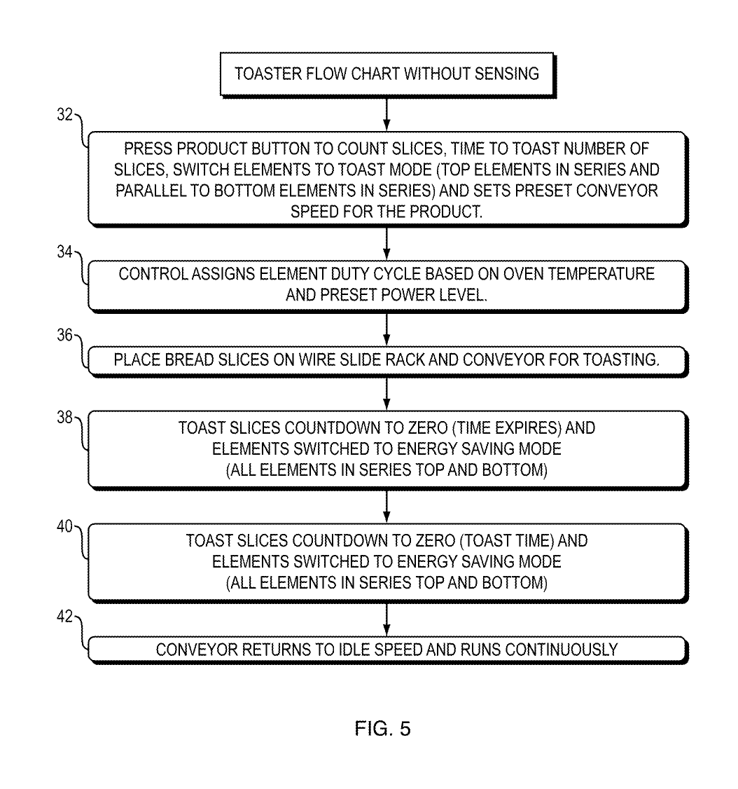

Referring to FIG. 5 shows a flow chart of the process steps provided by a digital controller (not shown) and relay (also not shown) in the embodiment without the use of a sensor. In step 32, an operator places the product to be toasted on conveyor 14 and selects a product type. In step 34, the digital controller assigns the element a duty cycle based on the oven temperature. In step 36, the heating elements cycle at an assigned duty cycle until the operator pre-set time is reached. After the pre-set time is reached, in step 40, the heating elements are switched into the series for the energy saving mode or idle mode. Step 42 has the conveyor 14 running continually.

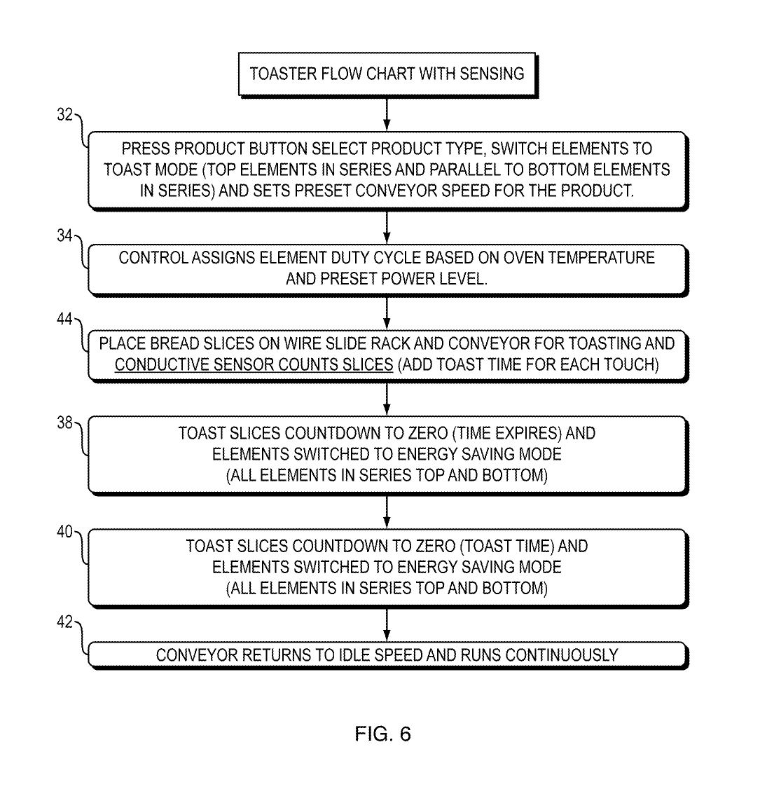

In FIG. 6, the preferred embodiment shows the process steps necessary when using a sensor (not shown). The sensor is a typical “capacitance touch” type that is well in the art. The product to be toasted touches a conductive feeder or conductive conveyor, which is isolated from the grounded skin of the toaster. The product has a capacity to hold electrons and when the product touches a conductive feeder or conveyor the switch circuit detects the additional electrons. This circuit is connected to the toaster control which automatically increments the product count each time a slice of bread or product touches the feeder or conveyor. This eliminates the necessity to manually push the control button each time a slice or product to toast is added. This capability would be part of the digital control board. The sensor would be located on the wire rack (not shown) or conveyor 14 where the product is placed for toasting. Step 32 is as previously discussed in the non-sensor embodiment. Once a product is placed on the wire rack or conveyor 14; the sensor senses a change in capacitance thereby providing a signal to the controller indicated by step 44.

In step 38, the controller checks to see whether the unit is in idle or is toasting. When the unit is in toasting mode and the “toast” mode times out, step 40 switches elements to FIG. 4 energy saving mode.

Step 32 causes heating elements 24-31 to be changed to the toasting mode as shown in FIG. 3. Further, the duty cycle is assigned based on the temperature and product previously selected by the operator.

Once the cycle is completed, step 38 causes the unit to “time out”. In step 40, also shown in FIG. 5, the heating elements 24-31 then switch back again to the top and bottom four heating elements being connected in series. Finally, in step 42, conveyor 14 continues to run.

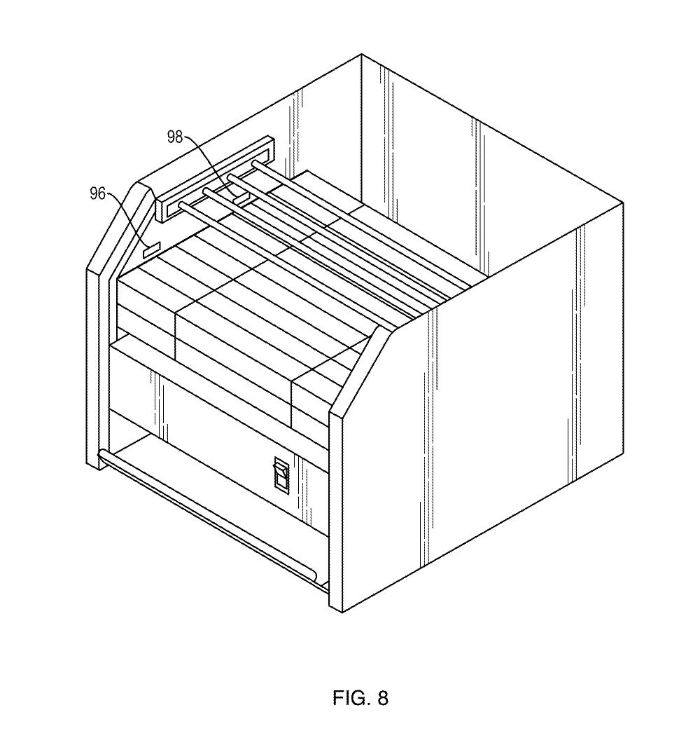

Referring now to FIGS. 7 and 8, the control panel and temperatures of the toaster apparatus 10 is shown. This enables the toaster to provide the same toast color as the cavity temperature in the toaster changes with use or lack of use.

When the toaster is in the idle mode, the cavity temperature is monitored by temperature probe 96. If the cavity temperature measured is decreasing over time, it is designated as a “fall” and if the cavity temperature measured is increasing over time, it is designated as a “rise”.

On/off switch 80 is comparable to switch 18 shown on FIG. 1. For lighter toasting, button 82 is selected. For darker toast, button 84 is pushed. These buttons correspond to pre-set power level settings, 1 through 5. If a user level is set on power level, for example, a user pushing the “dark” button 84 will cause the unit to shift to power level 4. If the user presses the “light” button 82, the power level will shift to 2. If the apparatus has already been set at 5, the power level will not go up. However, the power level can go down to 4 if the “light” button 82 is pressed. Also, at no time will the power level lower to “off” even if the power level is set at 1 and then the “light” button 82 is pressed.

If a user wants to place the unit in “stand-by” mode, button 86 is pushed for energy saving operation. Depending on the product that is to be toasted, button 88 for toast, button 90 for muffins, button 92 for bagels can be selected. Button 94 over-rides the automatic toast color feature if desired and the apparatus will run full-on until the unit times out (2 hour factory default) or until E-SAVE button 86 is pressed. This button 94 is useful during times when a user wants to obtain the maximum throughput such as lunch time or breakfast.

If button 86 is pushed, the toaster immediately goes into “energy save” mode.

The automatic toast color feature operates as follows. First, the toasting characteristics of a particular toaster are measured by setting the cavity at the lowest likely cavity temperature that the unit should see during toasting. This temperature is designated as the “base cavity temperature”.

For example, with the preferred model of the toaster disclosed herein, that temperature measured at probe 98 is 300 degrees. Both probe 98 and probe 96 are preferably resistant temperature detectors or RTD's.

Next, the time that product takes to travel from the front of conveyor 14 to the back where the product drops down the chute is determined and designated as “tested base time”. In this case, the time is 65 seconds. This value could be changed depending on belt speed, length of the conveyor and so on. Also, different units will have differing base temperature measurements and test base times but the process can be scaled easily to accommodate different toaster characteristics.

The energy requirements to obtain a desired predetermined color were measured and designated as “base joules”. In this case, the value obtained was 33.65 joules.

Then the test was run again with the cavity temperature increased as measured by probe 98. The conveyor speed was kept at 65 seconds. Once the toast color was the same as the prior test, the energy requirements for that condition were measured. This test was again repeated several times at differing cavity temperatures and the data obtained yielded an empirically derived formula. This formula showed the amount of energy needed at different cavity temperatures to keep relatively the same toast color. If the same toast color was to be obtained as a faster speed, the formula could be rearranged to keep the heating elements on all the time and increase the conveyor speed so that toast was exposed to the same amount of energy. If a darker degree of toasting was wanted, the base joules could be changed to a higher number.

The steps of this power level adjustment process are as follows:

1. Temperature from temperature probe 96 and temperature probe 98 is read into memory. Probe 96 is used to determine whether a product has been placed on conveyor 14. If the temperature measured by probe 96 is on the “rise”, then time for measurement is 20 seconds, if the temperature measured by probe 96 is on the “fall”, then time for measurement is 30 seconds.

2. Subtract the base cavity temperature from the temperature reading on probe 98 cavity temperature. Recall that the base cavity temperature is obtained experimentally.

3. Then, the difference between the two is multiplied by the joules per degree. In this case, which is “on the fall”, that number is 0.09. Joules per degree is obtained as the difference in temperature from the current cavity temperature provided by probe 98 to the tested base cavity temperature determined by experiment as described above. In the case of a “fall”, that number is 0.09 and in the case of a “rise” that number is 0.12.

4. That result is then subtracted from the base joules value that was previously calculated. In this case, that number is 33.65.

5. That number yields joules required at a temperature measured by probe 98. This number is divided by the joules per second. Joules per second is derived from the wattage of the toaster unit divided by the number of seconds in an hour or 3600.

6. This number reveals the total time that the heating elements “x” must be on during the 65 second traverse of the product on conveyor 14.

7. Finally, the result above is divided by duty cycle, which in this example is 65 seconds or the time that a product takes to traverse the conveyor 14.

The algorithm for the toaster was developed with the goal of getting the same toast color as the cavity temperature in the toaster changed with use or lack of use. Explanation of the algorithm in the “idle” mode must be presented to understand the algorithm when the product key is pressed. When in the “idle” mode, the toaster monitors the cavity temperature to see if the toaster cavity is rising in temperature or falling in temperature. If the cavity temperature is falling then the toaster assigns a different duty cycle to the elements then it would if the cavity temperature was rising. A rising cavity temperature will be called “Rise” and a falling cavity temperature will be called “Fall” in the following content.

The temperature from probe 1 (96) and probe 2 (Cavity Temperature—98) is read to memory. The temperature from probe 1 is monitor for 20 seconds if the unit is on the fall and 30 seconds if the unit is on the rise. The temperature reading from probe 2 is placed into the following:

Formula (((Base Joules−(cavity temp−Base Temp)×joules per Degree)/joules per sec)/65)/2

Example on the fall (((33.65−(probe 2−Base−300)×0.09)/0.3889)/65)/2

After the duty cycle has been calculated, the control reads the user-defined power level from memory. (0, 1, 2, 3, 4 or 5). If the power level is set at 3, the duty cycle will be the calculated answer from the formula. If the power level is 1, it will be the calculated answer subtracted 30%. If the power level is 2, subtract 20% and power level 4 adds 20% and 5 is 30%.

At the same time probe 1 is being read every second for either 20 or 30 seconds depending on whether it is rising or falling in temperature when the toast button is pressed. If probe 1 drops more than 2 degrees in that time frame, it will add another 40% to the duty cycle. If probe 1 does not see a drop in temperature in that time frame, it will stay at the assigned duty cycle until the cycle time is complete.

For example, with an “on the fall” probe 98 of 15 degrees, that is obtained by the measurement at probe 98 and obtaining 315 degrees and then subtracting the base cavity temperature of 300 degrees.

The number 15 is multiplied by joules per degree, that is, 0.09.

The answer of 1.35 is subtracted from the base joules of 33.65.

This result of 32.3 is divided by joules per second of 0.777, which results in 41.53 joules. Finally, this result is divided by the base tested time of 65 seconds which yields of a duty cycle that will keep the heating elements on 63.8% of the time.

The apparatus is equipped to have a plurality of power levels, preferably five, as mentioned above, but more or less number of levels could be used depending on the range of color changes in the toasted product as well as the type of product that is being toasted.

In this embodiment, the five levels of power are as follows. Level 1 corresponds to 30% less than the power calculated using the above process. Level 2 is 20% less. Level 3 is the calculated power level. Level 4 is 20% more and level 5 is 30% more than the calculated power.

As noted above, probe 96 is used to determine whether a product has been placed on conveyor 14. If the toast button 88 is pressed and if probe 96 indicates a “fall” of more than 2 degrees in the time frame measured, then the power level calculated by the above method will be increased by 40% due to the amount of product that has been placed on conveyor 14. If this level of “fall” isn't detected, the duty cycle will remain as calculated until the cycle time is complete.

If the bagel or muffin button is pressed, the apparatus always assumes that both halves of a bagel or muffin have been placed on the conveyor and, therefore, adjusts the apparatus accordingly.

Although the present invention has been described with reference to certain preferred embodiments thereof, other versions are readily apparent to those of ordinary skill in of the preferred embodiments contained herein.

What is claimed is:

1. A toasting apparatus comprising:
a conveyor for transporting products to be toasted into and out of said apparatus;
a plurality of top heating elements positioned above said conveyor wherein said plurality of top heating elements are connected in series with one another; and
a plurality of bottom heating elements positioned below said conveyor also connected in series with one another;
wherein said top and bottom plurality of heating elements are powered by a supply voltage;
a first relay connected between said plurality of top heating elements and said plurality of bottom heating elements;
a second relay connected between said plurality of top heating elements and the supply voltage;
a third relay connected between said plurality of bottom heating elements and the supply voltage.

2. The toasting apparatus of claim 1 further comprising:
control means for controlling element duty cycle, conveyor speed, and the circuitry of said apparatus by activating said first, second, and third relays.

3. The toasting apparatus of claim 2 wherein closing said second and third relays and opening said first relay places said plurality of top heating elements in a parallel connection with said plurality of bottom heating elements thus provides either a “start” mode or a “toast” mode and wherein closing said first relay and opening said second and third relays places said plurality of top heating elements in a series connection with said plurality of bottom heating thus provides an “energy saving”/“idle” mode.

4. The toaster apparatus of claim 3 further comprising;
at least two temperature sensors for measuring the temperature in said apparatus wherein once said control means detects that a pre-set oven temperature has been reached, said controlling means changes said apparatus to operate at said “energy saving”/“idle” mode.

5. The toaster apparatus of claim 3 wherein said control means sets the amount of time said apparatus is in the “toasting” mode before returning said apparatus to the “energy saving”/“idle” mode to provide a stand-by condition.

6. The toaster apparatus of claim 4 further comprising contact sensor means associated with said conveyor for determining whether a product has been placed in said apparatus for toasting and wherein said control means sets another duty cycle time to toast the product that has been sensed.

7. The toaster apparatus of claim 6 wherein if said contact sensor means detects a product to be toasted, and if said control means detects that said apparatus has been in the “energy saving”/“idle” mode for more than a predetermined amount of time, said control means initiates a “start” mode, followed by a “toasting” mode; and if said apparatus is in the “energy saving”/“idle” mode for less than the predetermined amount of time, said control means initiates the “toasting” mode with another duty cycle time.

8. A toaster apparatus having an oven, said apparatus comprising:
a programmable conveyor having a conveyor speed for transporting products that are to be toasted in said apparatus;
temperature sensing means for determining the temperature in the oven;
selection means for selecting the number and type of products to be toasted; and
timer means for setting a total time to toast all products that are to be toasted at the preprogrammed conveyor speed;
control means for calculating a duty cycle of said plurality of heating elements to provide the same toast color irrespective of measured oven temperature.

9. The toaster apparatus of claim 8 wherein said control means calculates the duty cycle by inputting the oven temperature provided by said temperature means into the formula:
(((Base Joules minus (oven temperature minus experimentally obtained Base Temperature−typically 300) times Joules per degree−a temperature change constant) divided Joules per second) divided by 65) divided by 2.

10. The toaster apparatus of claim 9 wherein said temperature selection means further comprises:
a first temperature probe positioned near the entrance to said conveyor;
a second temperature probe positioned in the oven of said apparatus;
wherein the temperature change constant is determined by monitoring said first temperature probe for a set period of time depending on whether said first temperature is rising or falling.

11. The toaster apparatus of claim 10 wherein said temperature change constant is 0.09 if the temperature of said first probe is falling and wherein said temperature change constant is 1.2 if temperature of said first probe is rising.

12. The toaster apparatus of claim 11 wherein the set period of time for monitoring is 20 seconds if a “fall” is indicated or for monitoring is 30 seconds if a “rise” is indicated.

13. The toaster apparatus of claim 8 further comprising:
power level selection providing a user selectable range of power levels which will adjust the duty cycle, either raising the duty cycle or lowering the duty cycle depending on the power level selected.
